(19) United States
(12) Patent Application Publication
(10) Pub. No.: US 2009/0258524 A1
(43) Pub. Date: Oct. 15, 2009

(54) Electrical Fixture Connection Assembly

(76) Inventor: James Christopher Patrick McEnery, Warwickshire (GB)

Correspondence Address: GORDON & JACOBSON, P.C., 60 LONG RIDGE ROAD, SUITE 407, STAMFORD, CT, 06902, US

(21) Appl. No.: 12/281,415

(22) PCT Filed: Mar. 2, 2007
(86) PCT No.: PCT/GB2007/050094

§ 371 Date: Nov. 23, 2008

(30) Foreign Application Priority Data
Mar. 3, 2006 (GB) 0604271.7

(51) Int. Cl. H01R 13/625

(52) U.S. Cl. 439/334

(57) ABSTRACT

An electrical fixture connection assembly comprising a socket assembly, a plug assembly, and first and second fixing arms. A socket plate defines first and second socket apertures. Live and neutral electrical terminals are provided on the internal face of the socket plate. An earth terminal is provided within the socket housing at the distal end of a spring. The first and second fixing arms are provided on a carrier member and are movable between an open position in which the fixing arms extend out through fixing apertures in the socket housing and a closed position in which they are received within the socket housing. A resilient spring acts to bias the fixing arms in the open position. A live contact, a neutral contact, and an earth contact are provided on first, second and third plug arms of the plug assembly.

### BACKGROUND OF THE INVENTION

1. Field of the Invention

The invention relates to an electrical fixture connection assembly.

2. State of the Art

Installing or replacing electrical fixtures, such as ceiling lights, can be difficult for a single person to complete. To remove an existing ceiling light fixture, the light fixture must be support while the cover plate is removed to allow access to the wiring of the electrical fixture and the lighting circuit of the building, and the wiring must then be disconnected from the lighting circuit. A new ceiling light can then be installed, requiring the connection of its wiring to the lighting circuit and the replacement of the cover member, whilst supporting the new light fixture. It can be similarly difficult to replace or install other ceiling mounted electrical fixtures such as fire alarms, smoke detectors and intruder/movement sensors, and wall mounted electrical fixtures, such as lighting fixtures, fire alarms, smoke detectors and intruder/movement sensors.

### SUMMARY OF THE INVENTION

According to an aspect of the invention there is provided an electrical fixture connection assembly for installing an electrical fixture on a building surface, the assembly comprising:

a socket assembly for location through an aperture provided in a building surface, the socket assembly comprising:
a socket housing having at least one wall and being substantially open at one end;
first and second electrical terminals provided within the socket housing; and
first and second fixing apertures provided in the at least one wall of the socket housing;
   a plug assembly comprising:
first and second electrical contacts for electrical connection to an electrical fixture and for electrical coupling within the socket housing to the first and second electrical terminals; and
fixing means for mechanically coupling the electrical fixture to the plug assembly;
   mechanical coupling means for mechanically coupling the plug assembly to the socket assembly, such that the first and second electrical contacts are respectively brought into electrical connection with the first and second electrical terminals; and
   first and second fixing arms movably mounted within the socket housing, the fixing arms being moveable between an open position, in which each fixing arm extends out through the respective fixing aperture for engagement with the rear side of the building surface, and a closed position in which the fixing arms are substantially received within the socket housing, to enable the socket housing to be located through the aperture in the building surface.

Once the socket assembly has been installed on a building surface, an electrical fixture can easily be installed by mechanically coupling the electrical fixture to the plug assembly, which can be done away from the building surface, and then mechanically coupling the plug assembly to the socket assembly, thereby installing the electrical fixture on the building surface. The electrical fixture may subsequently be easily removed by de-coupling the plug assembly from the socket assembly. A replacement electrical fixture, mechanically coupled to the same plug assembly or to a second plug assembly, can then be installed on the building surface.

Preferably, the mechanical coupling means comprises a socket plate extending internally across the socket housing towards its open end and defining first and second socket apertures and first and second plug arms provided on the plug assembly to be received through the respective socket apertures.

Preferably, the first electrical terminal is a live terminal and the second electrical terminal is a neutral terminal, and the first electrical contact is a live contact and the second electrical contact is a neutral contact. The live and neutral electrical terminals are provided on the internal face of the socket plate and the live and neutral electrical contacts are respectively provided on the complementary faces of the first and second plug arms.

The live electrical contact is therefore not easily accessible following installation, thereby reducing the risk of electrical shock to a user.

Preferably, the socket assembly further comprises an earth terminal provided within the socket housing and the plug assembly further comprises an earth contact arranged to be electrically coupled to the earth terminal. The earth terminal is preferably movably mounted on a resilient member located within the socket housing behind the socket plate, and the earth contact is mounted on a third plug arm correspondingly located on the plug assembly, such that when the plug assembly is pushed into the socket assembly the earth contact pushes against the earth terminal and the resilient member until the first and second plug arms are received through the socket apertures, allowing the plug assembly to be rotated within the socket housing to move the first and second plug arms across the internal face of the socket plate, to thereby bring the live and neutral contacts into electrical contact with the live and neutral terminals respectively.

The earth contact and earth terminal are thereby the first to be electrically coupled (“first to make”) on installation of an electrical fixture and last to be de-coupled (“last to brake”) during removal of an electrical fixture. The resilient member ensures that the contacts and terminals are positively mechanically coupled, thereby ensuring good electrical coupling.

Preferably, the socket housing further comprises a terminal housing extending internally from its other end, the earth terminal and the resilient member being received by the terminal housing. The terminal housing is preferably provided with first and second terminal guards, extending around part of the terminal housing. The terminal guards preferably comprise a first, part cylindrical part being spaced from and extending around part of the terminal housing and a second, planar part extending generally radially outwardly from the first part. The terminal guards prevent a user from making manual contact with the live terminal or the neutral terminal.

The internal edges of the first and second socket apertures in the direction of rotation of the first and second plug arms are preferably chamfered to allow easy movement of the first and second plug arms from the plug apertures across the socket plate. Preferably, first and second stop members are provided generally adjacent the chamfered edges of the first and second socket apertures, the live and neutral contacts fouling against the stop members unless the plug assembly is further pushed into the socket housing, against the resilient member, to lift the live and neutral contacts over the respective stop members, the stop members thereby preventing the plug assembly from accidentally disengaging from the socket assembly.

Each electrical terminal and each electrical contact may comprise a contact block. Alternatively, each electrical terminal may comprise a contact plate and each electrical contact comprise a contact pin.

The first and second fixing arms are preferably provided with engagement formations at their distal ends, most preferably a plurality of engagement teeth. The first and second fixing arms are preferably provided at either end of a carrier member. The carrier member and fixing arms are preferably provided as a single, generally U-shaped strap. Preferably, the carrier member has a centrally located aperture for receiving the terminal housing. The socket assembly is preferably substantially closed at its other end and further comprises at least one second resilient member, extending internally between the closed end and the carrier member, the at least one second resilient member biasing the first and second fixing arms into the open position. The at least one second resilient member preferably comprises at least one second resilient spring.

The socket housing can therefore be easily installed in an aperture in a building surface without requiring screw fixings to be located into the building surface, whilst additionally avoiding damage to the building surface.

The connection assembly preferably further comprises an actuation tool operable to move the first and second fixing arms from the open position to the closed position, against the action of the resilient member. The actuation tool is preferably of a size and shape such that it may be received within the socket housing when the fixing arms are in the closed position, to retain the fixing arms in the closed position during insertion of the socket housing through the aperture in the building surface.

The location of the socket assembly through the aperture in the building surface can therefore be a single-handed operation.

The fixing means preferably further comprises an adaptor plate for enabling larger electrical fixtures to be coupled to the plug assembly, the electrical fixture being mechanically coupled to the adaptor plate and the adaptor plate being mechanically coupled to the plug assembly.

The connector assembly preferably further comprises anchor means for mechanically anchoring the socket housing to a building support structure, to thereby enable the connector assembly to be used with heavy electrical fixtures. The anchor means may comprise a screw fixing or may comprise an anchor cable.

An embodiment of the invention will now be described in detail, by way of example only, with reference to the accompanying drawings.

### BRIEF DESCRIPTION OF THE DRAWINGS

FIG. 1 is a diagrammatic representation of an electrical fixture connection assembly according to a first embodiment of the invention shown with the socket housing located through an aperture in an example section of ceiling plaster board;

FIG. 2 is a part exploded diagrammatic representation of the socket assembly of FIG. 1;

FIG. 3 shows an isometric view from above of the plug assembly of FIG. 1;

FIG. 4 is an exploded view of the plug assembly of FIGS. 1 and 3;

FIG. 5 is a view of the open end of the socket assembly of FIG. 1;

FIG. 6 is a view of part of the socket assembly of FIGS. 1 and 2, from its other end;

FIG. 7 is a view of further parts of the socket assembly of FIGS. 1 and 2;

FIG. 8 is a part exploded diagrammatic representation of an electrical fixture connection assembly according to a second embodiment of the invention; and

FIG. 9 is a cross-sectional view of the assembly of FIG. 8 in its assembled state.

### DETAILED DESCRIPTION OF THE PREFERRED EMBODIMENTS

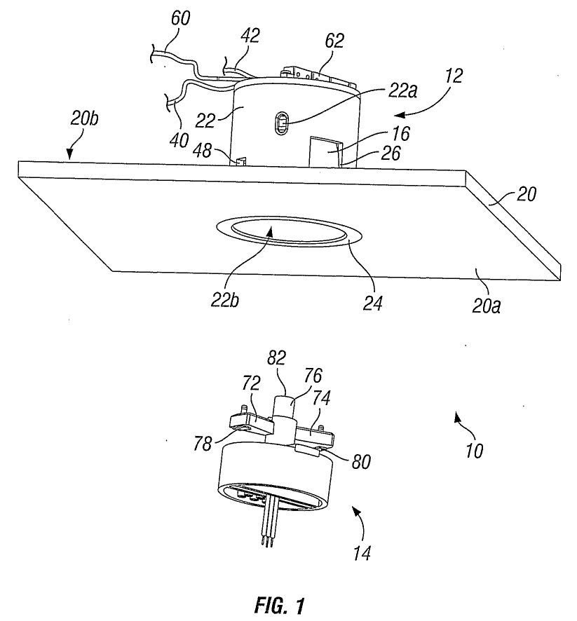

Referring to FIGS. 1 to 7, a first embodiment of the invention provides an electrical fixture connection assembly 10 comprising a socket assembly 12, a plug assembly 14 and first and second fixing arms 16,18.

In this example, the connection assembly 10 is shown with the socket assembly 12 located through an aperture in a building surface in the form of a section of ceiling plaster board 20. It will be appreciated that plaster boards are in general much larger than the section shown, and that the small size is selected merely for reasons of clarity in the drawing.

The socket assembly 12 comprises a cylindrical socket housing 22 which is open at one end 22b, with a lip 24 provided around the open end 22b; the lip 24, in use, being arranged generally flush with the external (room) side 20a of the plaster board 20. First and second fixing apertures 26, 28 are provided in the wall of the socket housing 22.

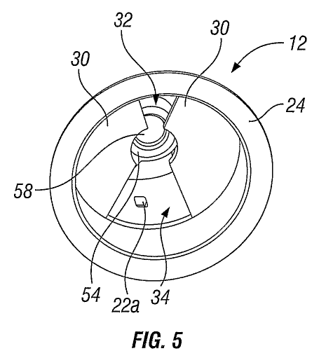

A socket plate 30 is provided internally across the socket housing 22, towards its open end 22b, as shown in FIG. 5. The socket plate 30 defines first and second socket apertures 32, 34. Live and neutral electrical terminals, in the form of Copper terminal blocks 36, 38, are provided on the internal face of the socket plate 30. Live and neutral cables 40, 42 are routed to the live and neutral terminals through respective cable housings 44, 46 provided on the internal wall of the socket housing 22. Windows 48, 50 are provided in the wall of the socket housing 22 through which a user may attach the live and neutral cables 40, 42 to the live and neutral terminals 36, 38.

The other end of the socket housing 22 is closed with a generally T-shaped top plate 52 which includes a terminal housing 54 extending into the socket housing 22. A resilient spring 56 is provided within the terminal housing 54. The earth terminal 58, connected to an earth cable 60, is provided at the distal end of the spring 56, within the terminal housing 54.

The live cable 40, neutral cable 42 and earth cable 60 are connected to the live, neutral and earth wires of the building's electrical (lighting) circuit via a terminal strip 62 provided on the external side of the top plate 52.

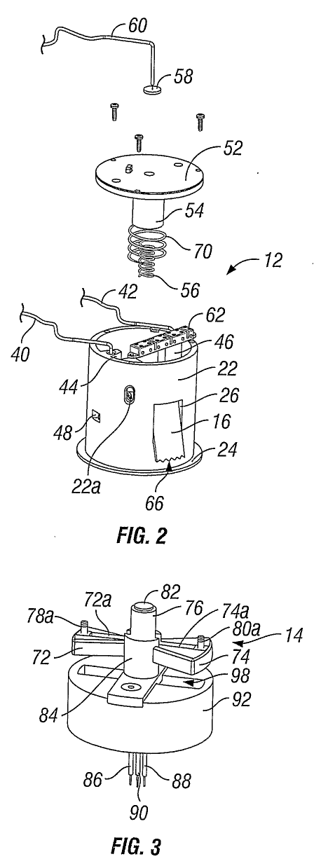

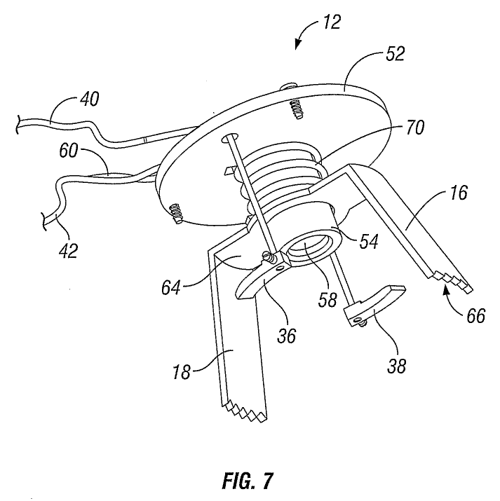

The first and second fixing arms 16, 18 are provided on a carrier member 64, as shown in FIG. 7. The fixing arms 16, 18 and the carrier member 64 of this example are provided as a single generally U-shaped metal strap. The fixing arms 16, 18 are connected to the carrier member 64 by live hinges, thereby allowing the fixing arms 16, 18 to flex relative to the carrier member 64. Engagement formations in the form of teeth 66 are provided at the distal end of each fixing arm 16, 18 for engagement with the internal side 20b (within the ceiling space) of the plaster board 20. The fixing arms 16, 18 are movably mounted within the socket housing 22, as described in more detail below. The fixing arms 16, 18 are moveable between an open position (shown in FIG. 2), in which each fixing arm 16, 18 extends out through its respective fixing aperture 26, 28 for engagement with the internal side 20b of the plaster board, and a closed position in which the fixing arms 16, 18 are substantially received within the socket housing 22, to allow the socket housing 22 to be located through the aperture in the plaster board 20.

A central, mounting aperture 68 is provided in the carrier member 64, through which the earth terminal housing 54 is received. A second resilient spring 70 is provided externally around the terminal housing 54, and extends between the top plate 52 and the carrier member 64. The resilient spring 70 acts to bias the fixing arms 16, 18 in the open position. In order to move the fixing arms 16,18 to the closed position the carrier member 64 must be pushed, against the force of the spring 70, towards the top plate 52, thereby drawing the fixing arms 16,18 into the socket housing 22.

An actuation tool (not shown) is provided for engagement with the carrier member 64, to allow a user to push the carrier member 64 upwards. When the fixing arms 16, 18 are in the closed position, the actuation member is received within the socket housing 22 and can be fixed in position within the socket housing 22, to retain the fixing arms 16, 18 in the closed position while the socket housing 22 is located through the aperture in the plaster board 20. Once the socket housing 22 is in position, the actuation tool is removed and the spring 70 pushes the carrier member 64 back down, causing the fixing arms 16, 18 to be pushed out through the fixing apertures 26, 28 and into engagement with the plaster board 20.

The socket assembly 12 may additionally comprise anchor lines (not shown) for connection between the socket assembly 12 and the building support structure (in the example of a ceiling plaster board, one or more ceiling rafters or joists). The anchor lines are connected to the socket assembly 12 via anchor apertures 22a provided in the socket housing 22. The anchor lines may take the form of screw fixings, to be screwed through the anchor apertures 22a into the side of an adjacent rafter or joist, or may take the form of wire cables to be attached to the socket assembly at one end and attached to a rafter or joist at the other end (this arrangement being particularly suitable for use when the desired location of the electrical fixture connection assembly 10 is not adjacent to a rafter or joist). The anchor lines serve to anchor the socket assembly 12 to the building structure, thereby enabling the electrical fixture connection assembly 10 to be used with heavy electrical fixtures.

The plug assembly 14, as shown in FIGS. 1, 3 and 4, comprises first, second and third plug arms 72, 74, 76, a live contact 78, a neutral contact 80, and an earth contact 82, and fixing means 84.

The first plug arm 72 is of a complementary size and shape to the first socket aperture 32 and the second plug arm 74 is of a complementary size and shape to the second socket aperture 34, such that the plug arms 72, 74 may be received through their respective socket apertures 32, 34. The live contact 78 is provided on the underside (as orientated in FIG. 1) of the first plug arm 72 and the neutral contact 80 is provided on the underside of the second plug arm 74, such that following insertion of the plug arms 72, 74 through the socket apertures 32, 34, clock-wise rotation of the plug assembly 14 brings the live contact 78 into mechanical and electrical contact with the live terminal 36 and brings the neutral contact 80 into mechanical and electrical contact with the neutral terminal 38.

The first and second plug arms 72, 74 are arranged generally opposite one another, and extend outwardly from a mounting column 84 provided the centre of the plug assembly 14. The third plug arm 76 extends generally upwardly (as orientated in FIG. 1) from the mounting column 84 and is generally rod shaped, of a size and shape suitable for receipt within the earth terminal housing 54 of the socket assembly 12. The earth terminal 82 is provided at the distal end of the third plug arm 76.

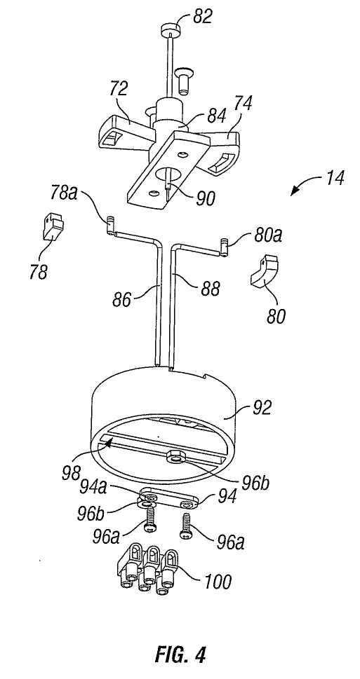

As shown in FIGS. 3 and 4, the live cable 86, neutral cable 88 and earth cable 90 of the plug assembly 14 extend centrally through the mounting column 84. The live cable 86 and the neutral cable 88 then extend along cable channels 72a, 74a provided in the top faces (as shown in FIG. 3) of the first and second plug arms 72, 74 to the live contact 78 and the neutral contact 80 respectively. The live and neutral cables 86, 88 are connected to their respective contacts 78, 80 by contact screws 78a, 80a. The earth cable 90 extends centrally through the third plug arm 76 to the earth contact 82.

The plug assembly 14 additionally comprises mechanical coupling means in the form of a coupling member 92, a coupling plate 94 and coupling screws 96a and nuts 96b. The coupling member 92 defines a coupling channel 98 and the coupling plate 94 has first and second coupling apertures 94a provided through it.

In use, the coupling plate 94 is placed lengthways along the underside (as shown in FIG. 4) of the coupling channel 98, the coupling screws 96a are located through fixing apertures in an electrical fixture (not shown) to be coupled to the plug assembly 14, and then through the coupling channel 98. The coupling nuts 96b are threaded onto the distal ends of the coupling screws 96a, on the other (uppermost) side of the coupling channel 98, thereby coupling the electrical fixture to the plug assembly 14.

The plug assembly 14 additionally comprises a terminal strip 100 (shown in FIG. 4) via which the live cable 86, neutral cable 88 and earth cable 90 of the plug assembly 14 are connected to the corresponding cables of an electrical fixture.

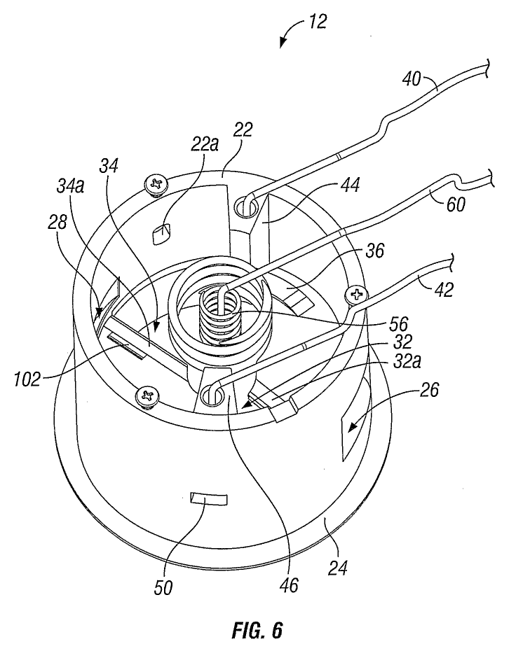

One edge 32a, 34a of each of the first and second socket apertures 32, 34 is chamfered to allow ease of rotation of the plug arms 72, 74 over the internal face of the socket plate 30, as shown in FIG. 6. The socket assembly 12 further comprises stops 102 (only one is visible in FIG. 6) provided adjacent to the chamfered edges 32a, 34a. On counter-clockwise rotation of the plug arms 72, 74, the live contact 78 fouls against the stop 102 adjacent the chamfered edge 32a of the first socket aperture 32 and the neutral contact 80 fouls against the stop 102 adjacent the chamfered edge 34a of the second socket aperture 34. The stops 102 thereby prevent accidental disengagement of the plug assembly 14 from the socket assembly 12.

In order to remove the plug assembly 14 from the socket assembly 12, the plug assembly 14 must be pushed upwards (as orientated in FIG. 1), towards the top plate 52 of the socket assembly 12, against the action of the first spring 56, as it is rotated, to lift the live and neutral contacts 78, 80 over the stops 102.

In an alternative arrangement, the coupling plate 94 may define larger coupling apertures to allow for variation in the fixing points on electrical fixtures to be coupled to the plug assembly 14. In addition, the plug assembly 14 may further comprise an adaptor plate for use with larger electrical fixtures; the adaptor plate is coupled to the coupling member 92 using the coupling plate 94 and coupling screws 96a and nuts 96b, as described above. The electrical fixture is then coupled to the adaptor plate using a similar coupling mechanism. The use of anchor lines may also be desirable when the electrical fixture connection assembly 10 is to be used with larger electrical fixtures.

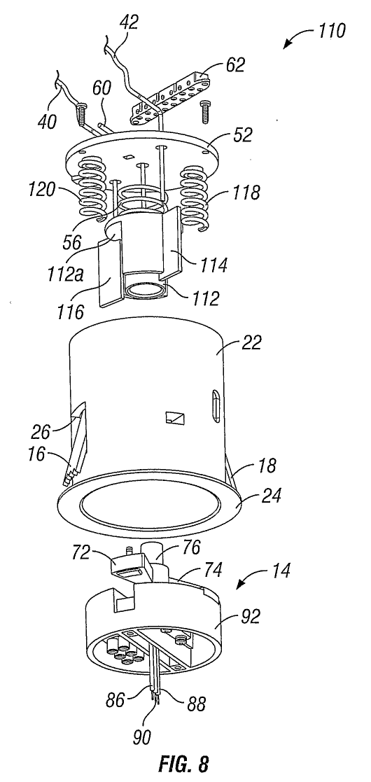

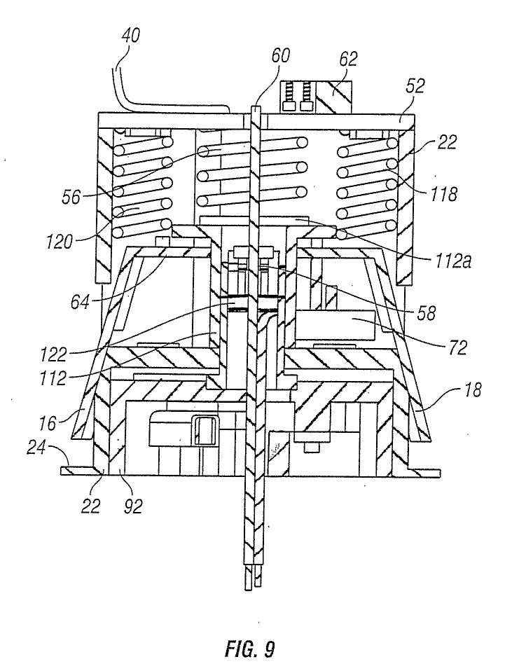

An electrical fixture connection assembly 110 according to a second embodiment of the invention is shown in FIGS. 8 and 9. The connection assembly 110 of this embodiment is substantially the same as the connection assembly 10 of the first embodiment, with the following modifications. The same reference numbers are retained for corresponding features.

In this embodiment the earth terminal housing 112 is provided separately to the top plate 52, and the connection assembly 110 further comprises terminal guards 114, 116 and two second resilient members in the form of second springs 118, 120.

The earth terminal housing 112 is provided with an engagement member 112a at its uppermost (as orientated in the drawings) end which engages one end of the first resilient spring 56, the spring 56 being provided between the engagement member 112a and the top plate 52. The earth terminal housing 112 is located through the central aperture 68 in the carrier member 64, such that the underside of the engagement member 112a engages with the part of the carrier member 64 around the central aperture 68. The earth terminal 58 is mounted within a terminal mount 122 within the earth terminal housing 112. The second springs 118, 120 extend between the top plate 52 and the regions of the carrier member 64 towards the fixing arms 16,18, i.e. the regions beyond the area covered by the engagement member 112a, as best shown in FIG. 9.

The terminal guards 114, 116 extend downwardly (as orientated in the drawings) from the engagement member 112a and are spaced from the earth terminal housing 112. Each terminal guard 114, 116 comprises a first, part cylindrical part 114a, 116a arranged generally coaxially with the earth terminal housing 112, and a second, planar part 114b, 116b which extends radially outwardly from the respective first part 114a, 116a, towards the internal wall of the socket housing 22.

In use the connection assembly 110 operates substantially the same as the connection assembly 10 of the previous embodiment, with the following modifications.

In order to move the fixing arms 16, 18 to the closed position the carrier member 64 must be pushed towards the top plate 52 against the force of the first spring 56 and the two second springs 118, 120 in order to draw the fixing arms 16, 18 into the socket housing 22. When the plug 92 is inserted into the socket housing 22, the third plug arm 76 engages with the terminal mount 122 and the user must push the earth terminal housing 112 upwards, against the action of the first spring 56, in order to insert the plug arms 72, 74 through the socket apertures 32, 34; subsequent clock-wise rotation of the plug assembly 14 brings the live contact 78 into mechanical and electrical contact with the live terminal 36 and brings the neutral contact 80 into mechanical and electrical contact with the neutral terminal 38.

The terminal guards 114, 116 prevent a user from touching the live terminal 36 or the neutral terminal 38

Various modifications may be made to the described embodiment without departing from the scope of the invention. For example, the electrical terminals may alternatively comprise contact plates and the electrical contacts comprise contact pins. The socket housing may be of a different size and shape to that shown. The socket apertures and the plug arms may also be of a different size and shape to those shown. The first and second fixing arms may be provided with different engagement formations to the teeth shown, and the fixing arms may be provided separately to one another rather than as the single U-shaped strap shown.

1. An electrical fixture connection assembly for installing an electrical fixture on a building surface, the assembly comprising:
(a) a socket assembly for location through an aperture provided in a building surface, the socket assembly comprising:
(a_i) a socket housing having at least one wall and being substantially open at one end;
(a_ii) first and second electrical terminals provided within the socket housing; and
(a_iii) first and second fixing apertures provided in the at least one wall of the socket housing;
(b) a plug assembly comprising:
(b_i) first and second electrical contacts for electrical connection to an electrical fixture and for electrical coupling within the socket housing to the first and second electrical terminals; and
(b_ii) fixing means for mechanically coupling the electrical fixture to the plug assembly;
(c) mechanical coupling means for mechanically coupling the plug assembly to the socket assembly, such that the first and second electrical contacts are respectively brought into electrical connection with the first and second electrical terminals; and
(d) first and second fixing arms movably mounted within the socket housing, the fixing arms being moveable between an open position, in which each fixing arm extends out through the respective fixing aperture for engagement with the rear side of the building surface, and a closed position in which the fixing arms are substantially received within the socket housing, to enable the socket housing to be located through the aperture in the building surface.

2. An electrical fixture connection assembly as claimed in claim 1, wherein the mechanical coupling means comprises a socket plate extending internally across the socket housing towards its open end and defining first and second socket apertures and first and second plug arms provided on the plug assembly to be received through the respective socket apertures.

3. An electrical fixture connection assembly as claimed in claim 1, wherein the first terminal is a live terminal, the first contact is a live contact, the second terminal is a neutral terminal, the second contact is a neutral contact, an earth terminal is movably mounted on a resilient member located within the socket housing behind the socket plate, and an earth contact is mounted on a third plug arm correspondingly located on the plug assembly, such that when the plug assembly is pushed into the socket assembly the earth contact pushes against the earth terminal and the resilient member until the first and second plug arms are received through the socket apertures, allowing the plug assembly to be rotated within the socket housing to move the first and second plug arms across the internal face of the socket plate, to thereby bring the live and neutral contacts into electrical contact with the live and neutral terminals respectively.

4. An electrical fixture connection assembly as claimed in claim 3, wherein the internal edges of the first and second socket apertures in the direction of rotation of the first and second plug arms are chamfered.

5. An electrical fixture connection assembly as claimed in claim 4, wherein first and second stop members are provided generally adjacent the chamfered edges of the first and second socket apertures, the live and neutral contacts fouling against the stop members unless the plug assembly is further pushed into the socket housing, against the resilient member, to lift the live and neutral contacts over the respective stop members.

6. An electrical fixture connection assembly as claimed in claim 3 wherein the socket housing further comprises a terminal housing extending internally from its other end, the earth terminal and the resilient member being received by the terminal housing and the terminal housing being provided with first and second terminal guards, extending around part of the terminal housing.

7. An electrical fixture connection assembly as claimed in claim 6, wherein the terminal guards comprise a first, part cylindrical part being spaced from and extending around part of the terminal housing and a second, planar part extending generally radially outwardly from the first part.

8. An electrical fixture connection assembly as claimed in claim 1, wherein the first and second fixing arms are provided with engagement formations at their distal ends.

9. An electrical fixture connection assembly as claimed in claim 1, wherein the first and second fixing arms are provided at either end of a carrier member, the carrier member and fixing arms being provided as a single, generally U-shaped strap.

10. An electrical fixture connection assembly as claimed in claim 9, wherein the socket assembly is substantially closed at its other end and further comprises at least one second resilient member, extending internally between the closed end and the carrier member, the at least one second resilient member biasing the first and second fixing arms into the open position.

11. An electrical fixture connection assembly as claimed in claim 1, wherein the connection assembly further comprises an actuation tool operable to move the first and second fixing arms from the open position to the closed position, against the action of the resilient member, the actuation tool being of a size and shape such that it may be received within the socket housing when the fixing arms are in the closed position, to retain the fixing arms in the closed position during insertion of the socket housing through the aperture in the building surface.

12. An electrical fixture connection assembly as claimed in claim 1, wherein the fixing means further comprises an adaptor plate for enabling larger electrical fixtures to be coupled to the plug assembly, the electrical fixture to be mechanically coupled to the adaptor plate and the adaptor plate to be mechanically coupled to the plug assembly.

13. An electrical fixture connection assembly as claimed in claim 1, wherein the connector assembly further comprises anchor means for mechanically anchoring the socket housing to a building support structure.

14. An electrical fixture connection assembly as claimed in claim 13, wherein the anchor means comprise a screw fixing or an anchor cable.
